(19) United States
(12) Patent Application Publication
(10) Pub. No.: US 2005/0003874 A1
(43) Pub. Date: Jan. 6, 2005

(54) Mobile communication unit and antenna unit

(76) Inventors: Osamu Ebisawa, Tokyo (JP); Shigeru Suzuki, Saitama-ken (JP); Yasumasa Tsukida, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/812,885

(22) Filed: Mar. 31, 2004

(30) Foreign Application Priority Data
Apr. 1, 2003 (JP) 2003-097715

(51) Int. Cl. H01Q 1/24; H04M 1/00

(52) U.S. Cl. 455/575.7; 455/550.1

(57) ABSTRACT

A mobile communication unit has an antenna unit including an extensible rod element and a fixed element. While the rod element is held by an antenna holder which is fixed in the mobile communication unit main body with a fixing member made of conducting material, the fixed element is attached to the inner wall of a hollow and cylindrical antenna casing. The antenna holder is inserted in the antenna casing. The feeding end of the fixed element is in contact with a projection formed outside the lower metallic portion of the antenna holder. The fixed element is fed from an RF functional block in the main body through the fixing member connected with the RF functional unit, the antenna holder and the projection. The rotational position of the feeding end around the rod element extending direction is determined and by the projection and the depression portions formed on the antenna casing and the antenna mount. The configuration shows good reproducibility of the radiation pattern of the fixed element in spite of the non-uniformity around the rod element extending direction.

### CROSS REFERENCE TO RELATED APPLICATION

This application is based upon and claims the benefit of priority from the prior Japanese Patent Application No. 2003-97715 filed on Apr. 1, 2003; the entire contents of which are incorporated herein by reference.

### FIELD OF THE INVENTION

The present invention relates to a mobile communication unit having an antenna unit with an extensible rod element and a fixed element, and to the antenna unit having the same.

### DESCRIPTION OF THE BACKGROUND

An antenna for use in mobile communication units is known, which is provided with an extensible rod element, a fixed element, a hollow holder and a hollow casing.

The holder is hollow and cylindrical, and the upper and lower portions of the holder are made of non-conducting material and metals, respectively. An external screw is formed outside the lower metallic portion of the holder. The holder is screwed in a nut secured to the antenna mount of the communication unit main body.

munication unit main body.

The rod element is accommodated inside the holder and is extensible in the upper direction.

The fixed element is formed as a meander, for instance, to have enough electrical length within a limited space. The fixed element is wound outside the upper non-conducting portion of the holder, and draws an arc around the rod element extending direction when it is seen from the direction. The feeding end of the fixed element is the starting point of the arc and is connected with the lower metallic portion of the holder.

The hollow casing surrounds the holder and is fixed in the antenna mount of the main body, and thus the antenna is mounted in the main body.

The nut in the antenna mount is connected with the feeder line of the main body. The fixed element is electrically connected, through the lower metallic porttion of the holder, the nut and the feeder line, to the transmitter and receiver in the main body.

Further the rotational angle of the starting point of the arc of the fixed element varies depending on the given torque when the holder is screwed down to the antenna mount. The radiation pattern of the fixed element around the rod element extending direction is not uniform, because the uniformity depends on where the starting point of the arc is, and thus where the upper and lower turning segments of the meandrous shape of the fixed element are. The conventional antenna stated above thus has a disadvantage that the fixed element lacks in the reproducibility of the radiation pattern around the rod element extending direction.

Another antenna for use in mobile communication units is described in Japanese Patent Publication (Kokai) No. 2001-185926. This antenna has a coil element on the top of an extensible rod element. The top of the antenna has a projection (or a depression) which fits to a depression (or a projection) of the main body when the rod element is shortened. The coil element serves to reproduce its radiation pattern in the plane vertical to the rod element extending direction, as long as it is accommodated in the unit main body.

This configuration has a disadvantage, however, that the reproducibility depends on whether the antenna top is exactly made fit in the main body when the rod element is shortened. The configuration has, moreover, another disadvantage that the reproducibility is not assured when the rod element is extended.

### SUMMARY OF THE INVENTION

Accordingly, an advantage of the present invention is to provide good reproducibility of the antenna radiation pattern of mobile communication units.

To achieve the above advantage, one aspect of the present invention is to provide a mobile communication unit, comprising;
a main body having a hollow antenna mount formed on the main body, the antenna mount having a fitting portion formed inside and a fixing member of conducting material supported inside;
an RF functional unit contained in the main body and connected with the fixing member;
a hollow and cylindrical antenna holder including a portion of conducting material with a projection formed outside, the antenna holder being fixed in the hollow antenna mount by the fixing member;
a hollow and cylindrical antenna casing, having the antenna holder arranged inside, the antenna casing having a counter portion of the fitting portion outside;
a rod antenna element held by the antenna holder, the rod antenna element being extensible in the longitudinal direction; and
a fixed antenna element attached to the inner wall of the antenna casing, the fixed antenna element having a resilient feeding end pressed against and in contact with the projection.

In accordance with the aspect of the present invention, the fixed element fits to the mobile communication unit main body at a predetermined rotational angle around the rod element extending direction so that the reproducibility of the radiation pattern around the direction is improved.

### BRIEF DESCRIPTION OF THE DRAWINGS

FIG. 1 is a perspective view of the embodiment of a mobile communication unit and an antenna unit according to the present invention.

FIG. 2A is a cross sectional view of the antenna unit shown in FIG. 1 along the rod element extending direction.

FIG. 2B is an expansional view of the fixed element shown in FIG. 2A.

FIG. 2C is a cross sectional view along the line A—A of FIG. 2A.

FIG. 3A is a cross sectional view of the antenna unit and the antenna mount of the mobile communication unit main body along the same direction as the rod element extending direction of FIG. 2A.

FIG. 3B is a cross sectional view along the line B—B of FIG. 3A.

### DETAILED DESCRIPTION OF THE INVENTION

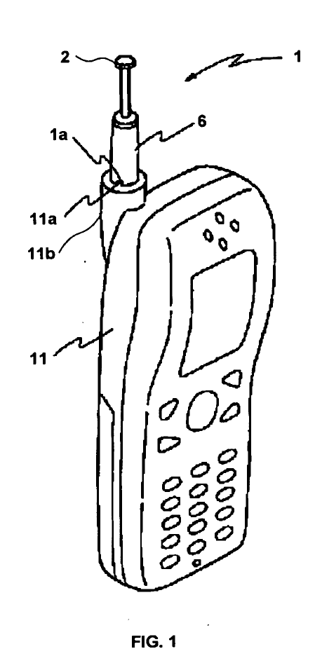

A mobile communication unit and an antenna unit embodying the present invention will be described with reference to the drawings FIG. 1 through FIG. 3B. As shown in FIG. 1 the mobile communication unit has an antenna unit 1 at the upper end of the main body casing 11. The antenna unit 1 has a rod element 2 and a hollow and cylindrical antenna casing 6. The rod element 2 can be extended upward and shortened downward to be accommodated into the antenna casing 6. The rod element 2 may be a resin-coated metallic pole.

While a depression 1a is formed on the surface near the lower end of the antenna casing 6, a projection 11a is formed in a hollow antenna mount 11b at the top of the main body casing 11 to fit the depression 1a.

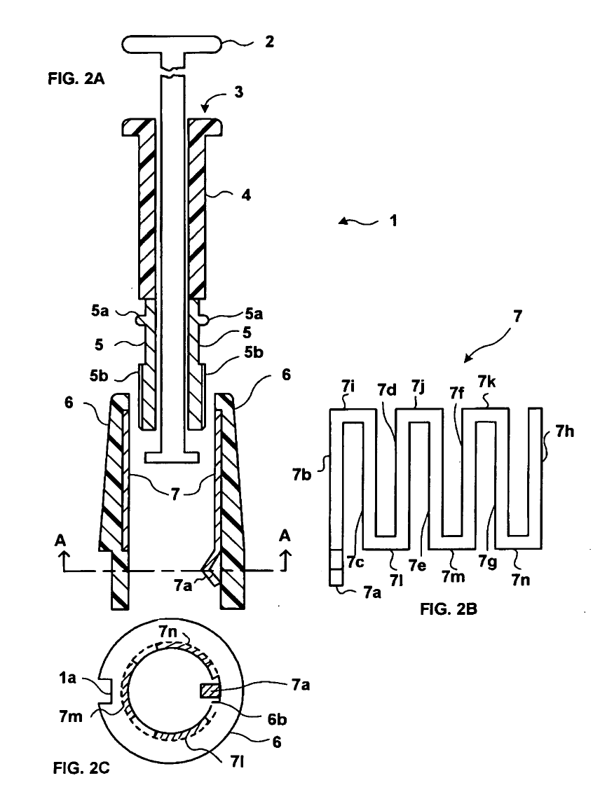

As shown in FIG. 2A the antenna unit 1 has, in addition to the rod element 2 and the antenna casing 6, a fixed element 7 attached inside the antenna casing 6 and a hollow and cylindrical holder 3 which mechanically holds the rod element 2.

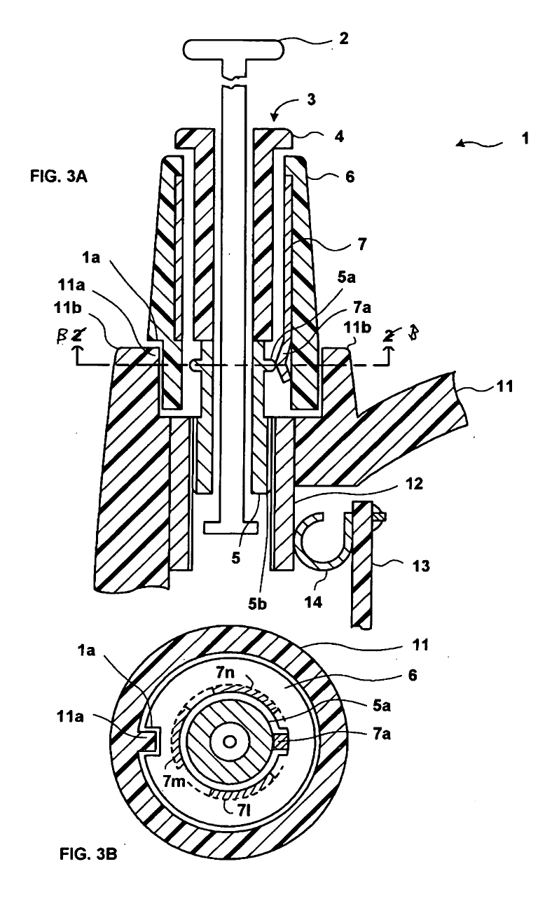

It is to be noted that FIG. 2A is illustrated, to be better understood, as the holder 3 is separate from the rod element 2. Their actual relative position when the antenna unit 1 is mounted in the antenna mount 11b is shown in FIG. 3A.

The holder 3 includes the upper non-conducting portion 4 and the lower metallic portion 5. A contacting ring 5a is formed on and around the upper end of the metallic portion 5. The metallic portion 5 contacts with the feeding end 7a of the fixed element 7 as shown in FIG. 3A. An external screw 5b is formed on and around the circumference of the lower end of the metallic portion 5.

FIG. 2B is an expansional view of the fixed element 7 which is formed as a meander. The fixed element 7 includes vertical parts 7b-7h, upper turning parts 7i-7k and lower turning parts 7l-7n. The feeding end 7a is an end of the fixed element 7 which is formed as a spring to be pressed against the contacting ring 5a, as shown in FIG. 3A.

FIG. 2C is a cross sectional view along the line A—A of FIG. 2A. As shown in this figure, the feeding end 7a of the fixed element 7 fits to a depression 6b formed on the inner wall of the antenna casing 6. The fixed element 7 including the lower turning parts 7l-7n is attached to a groove formed in the inner wall of the antenna casing 6. The fixed element 7 is arranged at a predetermined rotational position with respect to the depression 1a of the antenna casing 6.

FIG. 3A shows how the antenna unit 1 is mounted in the antenna mount 11b formed at the top of the main body casing 11. The projection 11a is formed inside the antenna mount 11b. The antenna mount 11b has a nut 12 supported inside. The main body casing 11 is provided with a printed circuit board 13 having a spring 14 which presses against the nut 12. The printed circuit board 13 is electrically connected with the nut 12. through the spring 14.

A mounting assembly process will be explained hereafter. The antenna casing 6 having the fixed element 7 inside is mounted in the hollow of the antenna mount 11b. The depression 1a of the antenna casing 6 fits to the projection 11a of the main body casing 11. This makes the fixed element 7 placed at a predetermined rotational position with respect to the projection 11a.

The holder 3 is inserted into the antenna mount 11b in a manner that the external screw 5b outside the lower metallic portion 5 of the holder 3 is screwed in the nut 12. As a result, the contacting ring 5a contacts with the feeding end 7a of the fixed element 7. The contact is assured since the feeding end 7a is formed as a spring and is pressed against the contacting ring 5a.

The top of the upper non-conducting portion 4 of the holder 3 is projected outwardly so that the antenna casing 6 is positioned between the top of the holder 3 and the antenna mount 11b of the main body casing 11. The upper non-conducting portion 4 hardly affect the radiation of the fixed element 7.

In the configuration shown in FIG. 3A, the fixed element 7 is fed by the RF functional unit which is not shown but on the printed circuit board 13 through the spring 14, the nut 12, the lower metallic portion 5, the contacting ring 5a and the feeding end 7a. The rod element 2 is fed by the RF functional unit through the spring 14, the nut 12 and the capacitor coupling between the lower metallic portion 5 and the rod element 2.

FIG. 3B is a cross sectional view along the line B—B of FIG. 3A. FIG. 3A clearly shows that the fixed element 7 including the lower turning parts 7l-7n is arranged at a predetermined rotational position with respect to the projection 11a. FIG. 3A also shows that the contacting ring 5a surely contacts with the feeding end 7a, as previously mentioned. The reproducibility of the radiation pattern of the fixed element 7 is assured because of the above positional constancy between the fixed element 7 and the main body casing 11.

It is obvious that a similar radiation pattern of the radiation pattern reproducibility is obtained when the fixed element 7 is formed as a coil instead of as a meander. It is also obvious that or when the antenna casing 6 has a projection in place of the depression 1a and the main body casing 11 has a depression in place of the projection 11a.

1. A mobile communication unit, comprising;
a main body having a hollow antenna mount formed on the main body, the antenna mount having a fitting portion formed inside and a fixing member of conducting material supported inside;
an RF functional unit contained in the main body and connected with the fixing member;
a hollow and cylindrical antenna holder including a portion of conducting material with a projection formed outside, the antenna holder being fixed in the hollow antenna mount by the fixing member;
a hollow and cylindrical antenna casing, having the antenna holder arranged inside, the antenna casing having a counter portion of the fitting portion outside;
a rod antenna element held by the antenna holder, the rod antenna element being extensible in the longitudinal direction; and
a fixed antenna element attached to the inner wall of the antenna casing, the fixed antenna element having a resilient feeding end pressed against and in contact with the projection.

2. A mobile communication unit according to claim 1, wherein the fitting portion is a projection and the counter portion is a depression.

3. A mobile communication unit according to claim 1, wherein the fitting portion is a depression and the counter portion is a projection.

4. A mobile communication unit according to claim 1, wherein the relative position between the fitting portion and the feeding end is predetermined.

5. A mobile communication unit according to claim 1, wherein the fixed antenna element is attached to a groove of the inner wall of the antenna casing, and the feeding end protrudes from the inner wall of the antenna casing.

6. A mobile communication unit according to claim 1, wherein the fixed antenna element is formed as a meander or a coil.

7. A mobile communication unit according to claim 1, wherein an end portion of the antenna holder is projected outwardly to hold the antenna casing between the end portion and the antenna mount.

8. A mobile communication unit according to claim 1, wherein the projection is a ring formed around the portion of the antenna holder and is pressed against the feeding end of the fixed antenna element.

9. A mobile communication unit, comprising;
a main body having a hollow antenna mount formed on the main body, the antenna mount having a fitting portion formed inside and a nut made of conducting material supported inside;
an RF functional unit contained in the main body and connected with the nut;
a hollow and cylindrical antenna holder including a portion of conducting material with a ring formed around the portion and an external screw formed around the portion, the antenna holder being fixed in the hollow antenna mount by the nut;
a hollow and cylindrical antenna casing, having the antenna holder arranged inside, the antenna casing having a counter portion of the fitting portion outside;
a rod antenna element held by the antenna holder, the rod antenna element being extensible in the longitudinal direction; and
a fixed antenna element attached to the inner wall of the antenna casing, the fixed antenna element having a resilient feeding end pressed against and in contact with the ring.

10. A mobile communication unit according to claim 9, wherein the relative position between the fitting portion and the feeding end is predetermined.

11. An antenna unit, comprising;
a hollow and cylindrical antenna holder including a portion of conducting material with a projection formed outside;
a fixing member made of conducting material and supported in the antenna mount of a mobile communication unit, the fixing member fixing the antenna holder in the antenna mount, the antenna mount having a fitting portion inside, and the mobile communication unit containing an RF functional unit in connection with the fixing member;
a hollow and cylindrical antenna casing, having the antenna holder arranged inside, the antenna casing having a counter portion of the fitting portion outside;
a rod antenna element held by the antenna holder, the rod antenna element being extensible in the longitudinal direction; and
a fixed antenna element attached to the inner wall of the antenna casing, the fixed antenna element having a resilient feeding end pressed against and in contact with the projection.

12. An antenna unit according to claim 11, wherein the fitting portion is a projection and the counter portion is a depression.

13. An antenna unit according to claim 11, wherein the fitting portion is a depression and the counter portion is a projection.

14. An antenna unit according to claim 11, wherein the relative position between the fitting portion and the feeding end is predetermined.

15. An antenna unit according to claim 11, wherein the fixed antenna element is attached to a groove of the inner wall of the antenna casing, and the feeding end protrudes from the inner wall of the antenna casing.

16. An antenna unit according to claim 11, wherein the fixed antenna element is formed as a meander or a coil.

17. An antenna unit according to claim 11, wherein an end portion of the antenna holder is projected outwardly to hold the antenna casing between the end portion and the antenna mount.

18. An antenna unit according to claim 11, wherein the projection is a ring formed around the portion of the antenna holder and is pressed against the feeding end of the fixed antenna element.

19. An antenna unit according to claim 11, wherein the projection is a ring formed around the portion and the fixing member is a nut, the portion further including an external screw formed around, and the antenna holder being fixed in the antenna mount by the nut.

20. An antenna unit according to claim 11, wherein the projection is a ring formed around the portion and the fixing member is a nut, the portion further including an external screw formed around, and the antenna holder being fixed in the antenna mount by the nut and, and the relative position between the fitting portion and the feeding end is predetermined.
